(19) United States
(12) Patent Application Publication
(10) Pub. No.: US 2006/0108778 A1
(43) Pub. Date: May 25, 2006

(54) Head protecting airbag apparatus

(75) Inventors: Yasuo Ochiai, Nishikasugai-gun (JP); Takanobu Ikeda, Nishikasugai-gun (JP); Masao Kino, Nishikasugai-gun (JP); Tadashi Yamamoto, Nishikasugai-gun (JP); Hitoshi Kawabe, Nishikasugai-gun (JP)

Correspondence Address: POSZ LAW GROUP, PLC, 12040 SOUTH LAKES DRIVE, SUITE 101, RESTON, VA, 20191, US

(73) Assignee: TOYODA GOSEI Co., Ltd., Aichi-ken (JP)

(21) Appl. No.: 11/253,580

(22) Filed: Oct. 20, 2005

(30) Foreign Application Priority Data
Oct. 21, 2004 (JP) 2004-307145
Nov. 26, 2004 (JP) 2004-341672

(51) Int. Cl. B60R 21/213

(52) U.S. Cl. 280/730.2; 280/742; 280/743.1

(57) ABSTRACT

A head protecting airbag apparatus of the invention which is folded up so as to be mounted in a accommodating position of a vehicle, wherein an inflating gas that is discharged from an inflator toward the front and rear of the vehicle is guided obliquely downward into an inflating shield portion of an airbag main body by a gas inlet port portion of the airbag main body and an inlet side portion of a regulator cloth.

### BACKGROUND OF THE INVENTION

1. Field of the Invention

The present invention relates to an airbag apparatus which includes an airbag that is folded up so as to be accommodated in a accommodating position of a vehicle so as to project from the accommodating position for expansion and deployment by allowing an inflating gas to flow thereinto and an inflator for supplying the inflating gas for the airbag.

2. Related Art

Conventionally, as head protecting airbag apparatuses like one that has been described above, there have existed head protecting airbag apparatuses in which an inflating gas from a tubular inflator disposed in a longitudinal direction of a vehicle is deflected downward by a metallic diffuser at a longitudinally intermediate portion of an airbag so as to allow the inflating gas so deflected to flow into the airbag and the inflating gas that has so flowed into the airbag is then distributed to the front and rear of the airbag (refer, for example, to JP-A-2003-146174).

Further, there have existed airbag apparatuses in which an airbag includes a tubular connecting port portion that is fitted on an inflator and connected thereto by being fastened by a clamp for enabling the inflow of an inflating gas from the inflator into the airbag (refer, for example, to JP-A-2003-11768).

However, a diffuser which is adapted to deflect downward inflating gas from an inflator disposed in the longitudinal direction of the vehicle needs to be bent and provided with a gas discharge port in a side thereof, and these facts have complicated the shape of the diffuser and increase the production costs thereof.

Further, in the aforesaid connecting construction in which the connecting port portion is connected to the inflator by utilizing only the clamp, for example, in the event that the output of the inflator increases as the volume of the airbag increases, there exists a risk that the connecting port portion is dislodged from the inflator when the inflator is activated, and hence there still exists a room for improvement in increasing the connection strength.

### SUMMARY OF THE INVENTION

The invention was made with a view to solving the problem and an object thereof is to provide a head protecting airbag apparatus which obviates the necessity of deflecting downward an inflating gas that is introduced from a longitudinally intermediate portion of an airbag.

Another object thereof is to provide an airbag apparatus which can increase the connection strength even in the event that the connecting port portion of the airbag is connected to the inflator by utilizing only the clamp.

According to the invention, there is provided a head protecting airbag apparatus mounted in an upper portion of a window of a vehicle, comprising:

an inflator having a gas discharge port which discharges an inflating gas in a longitudinal direction of the vehicle;

an airbag folded and adapted to be deployed downward so as to cover an interior side of the window when the inflating gas flows thereinto, the airbag including an airbag main body and a flexible regulator cloth,

wherein the airbag main body includes

an inflating shield portion which inflates by flowing the inflating gas thereinto to shield the interior side of the window, and

a gas inlet port portion connected to the inflator, projecting obliquely upward from an upper portion of the inflating shield portion except for portions in vicinity of a front end and a rear end thereof,

wherein the regulator cloth includes

a tubular inlet side portion disposed within the gas inlet port portion to be connected to the inflator and an outlet side portion disposed at a position on the inflating shield portion which is located in a vicinity of the gas inlet port portion,

the inlet side portion is adapted to guide downward the inflating gas discharged from the inflator, and

the outlet side portion includes a first gas outlet hole and a second gas outlet hole which are adapted to allow the inflating gas flowing out of the inlet side portion to flow, to a front side and a rear side along the inflating shield portion in a longitudinal direction of the vehicle.

In the head protecting airbag apparatus of the invention, since the inflating gas is discharged in the longitudinal directions, the gas deflecting unit such as the diffuser of the inflator can be simplified, thereby making it possible to reduce the production costs. Furthermore, since the gas discharged from the gas discharge port is in no case blown at right angles against a portion of the inlet side portion of the regulators cloth which oppositely faces the gas discharge port but is blown thereagainst so as to be guided obliquely downward, a damage that would be caused to the relevant portion by the inflating gas can be reduced. In addition, since the gas inlet port portion of the airbag main body is located outside the relevant portion so as to support the same portion, the damage that would be caused to the relevant portion by the inflating gas can be reduced further.

In addition, from the viewpoint of reducing the damage to the stitched portion which is weaker than the other portions, it is desirable that the inlet side portion of the regulator cloth is formed into a tubular shape from a single piece of cloth by a stitched portion that is formed using a stitching thread, and wherein the stitched portion is disposed so as not to face the gas discharge port.

In addition, it is desirable that a connecting portion between the inflating shield portion and a gas discharge side of the gas inlet port portion of the airbag main body or a portion in a vicinity of the connecting portion is fixed to a body of the vehicle. By adopting this configuration, the aforesaid effect of supporting the regulator cloth at the gas inlet port portion can be obtained in an assured manner.

According to the invention, there is provided an airbag apparatus including an airbag folded and accommodated in a accommodating position of a vehicle, capable of projecting from the accommodating position for expansion and deployment by flowing an inflating gas thereinto; and

an inflator for supplying the inflating gas for the airbag;

wherein the airbag includes a tubular connecting port portion fitted on the inflator and connected thereto by being fastened by a clamp for allowing the inflating gas from the inflator into the airbag, and

wherein the connecting port portion has a projecting portion provided at a position thereon which is located further forward than the clamp when the connecting port portion is connected to the inflator which prevents the connecting port portion from being detached from the inflator.

In the airbag apparatus of the invention, even in the event that the connecting port portion of the airbag is pulled so abruptly and violently as to attempt to be dislodged from the inflator at an early stage of inflation of the airbag after the connecting port portion fitted on the inflator has been connected to the inflator by fastening the clamp, the projecting portion is caught between the clamp and the inflator to thereby function as a wedge, which plays a role of preventing the dislodgement of the clamp and the connecting port portion from the inflator. Due to this, the connection strength of the connecting port portion to the inflator can be increased compared with the related art airbag apparatuses in which no such projecting portion is provided.

Consequently, in the airbag apparatus of the invention, even in the event that the construction is adopted in which the connecting port portion of the airbag and the inflator are connected to each other by making use of the clamp, the connection strength can be increased.

In addition, in the airbag apparatus of the invention, the projecting portion may only have to be provided on the connecting port portion, and hence the provision of such a projecting portion can easily be implemented without changing largely the design of the airbags used in the related art airbag apparatuses.

Furthermore, in the airbag apparatus that is configured as has just been described above, the projecting portion is preferably provided with a stitched portion that is formed by utilizing a stitching thread. In the airbag apparatus that is so configured, since the stitched portion may only have to be formed on the related art airbag by utilizing a stitching thread, the provision of the projecting portion can be implemented more easily.

Moreover, in the airbag apparatus that is configured as has just been described above, a configuration may be adopted in which a hollow or tubular weaving is provided at a position of the airbag where the connecting port portion is provided, and

the projecting portion is provided by changing a woven structure of the hollow or tubular weaving so that a thickness of the projecting portion is increased.

Note that while it can be considered that the connecting port portion can be made to have a double layer construction by providing an inner tube at the position where the connecting port portion is provided, even in the event that such an airbag is used, the projecting portion may be formed by providing a raised portion on the inner tube, and furthermore, the projecting portion may be formed by providing raised portion on both a position of the airbag which constitutes an outer peripheral side of the connecting port portion and the inner tube.

### BRIEF DESCRIPTION OF THE DRAWINGS

FIG. 1 is a schematic front view of a head protecting airbag apparatus of first embodiment of the invention which results when viewed from an interior side.

FIG. 2 is a partially enlarged view of a position of the airbag apparatus of the same embodiment where an inflator is provided.

FIG. 3 is a front view which shows a regulator cloth of the same embodiment.

FIG. 4 is a schematic enlarged sectional view which shows the vicinity of a connecting position between the inflator and an airbag main body of the airbag apparatus of the same embodiment.

FIG. 5 is a partially enlarged sectional view of a position where an inflator is provided in the airbag apparatus of second embodiment.

FIG. 6 is a schematic enlarged sectional view which shows the vicinity of a connecting position between the inflator and a connecting port portion of the airbag apparatus of the same embodiment.

FIG. 7 is a front view which shows a state in which an airbag of the same embodiment is deployed flat.

FIG. 8 is a front view which shows the airbag and an inner tube of the same embodiment.

FIG. 9 is a front view which shows an inner tube of another form.

FIG. 10 is a sectional view of a position on the inner tube shown in FIG. 9 where a projecting portion is provided.

FIG. 11 is a schematic diagram which shows part of a woven structure of the inner tube shown in FIG. 9.

### DETAILED DESCRIPTION OF THE PREFERRED EMBODIMENTS

### First Embodiment

First embodiment of the invention will be described below based on the drawings. A head protecting airbag apparatus is installed on a vehicle V so as to be mounted in a accommodating position formed to extend from a front pillar portion FP along a roof side rail portion RR on an upper portion of doors and windows W1, W2, W3 on an interior side thereof. Note that this vehicle is configured such that a first intermediate pillar portion P1 and a second intermediate pillar portion P2 are provided so as to extend substantially vertically between the front pillar portion FP and a rear pillar portion RP.

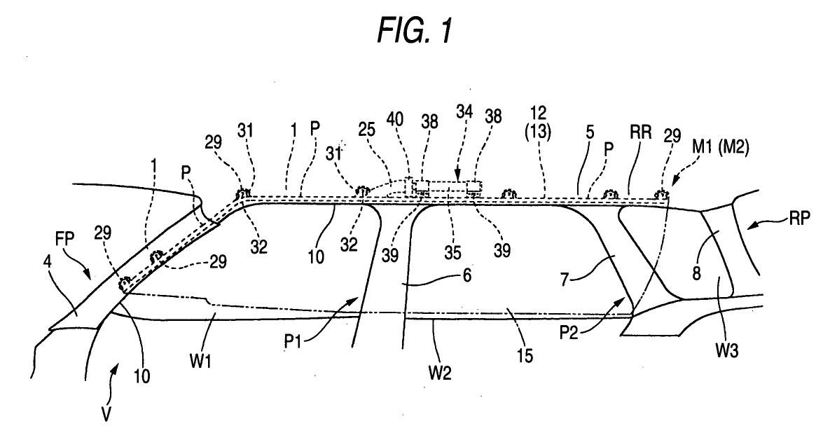

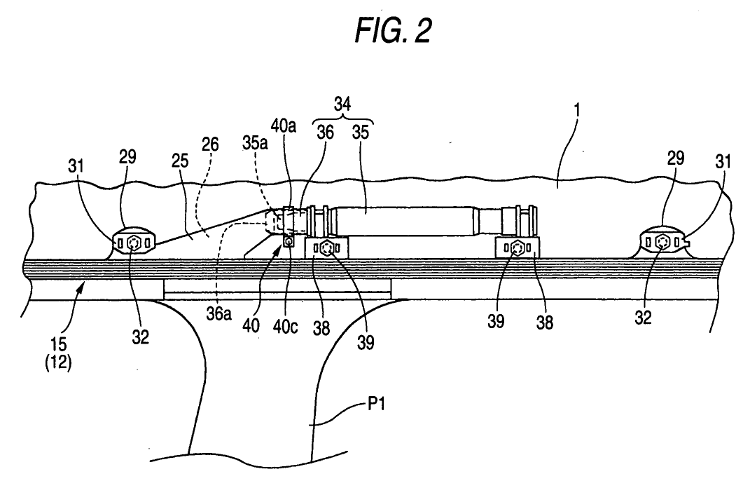

The head protecting airbag apparatus M1 is, as shown in FIGS. 1, 2, configured so as to include an airbag 12, an inflator 34, mounting brackets 31, 38, mounting bolts 32, 39 and a clamp 40 which connects the airbag 12 to the inflator 34 and is accommodated in the accommodating position in such a state that an interior side thereof is covered by an airbag cover 10 when installed on to the vehicle V. In the case of this embodiment, the airbag cover 10 is provided with a lower edge side position of a pillar garnish 4 which covers the interior side of the front pillar portion FP and a lower edge side position of a-roof lining 5 which covers the interior side of the roof side rail portion RR.

The pillar garnish 4 and the roof lining 5 are made of a synthetic resin and are mounted on an interior side of an inner panel which is a body 1 side member at the front pillar portion FP and the roof side rail portion RR by mounting means, which are not shown. Then, these lower edge side positions are constructed so as to open toward the interior side so as to allow the projection of the airbag 12 from lower edge sides thereof when the airbag 12 is inflated and deployed.

The airbag 12 is, as shown in FIG. 1, accommodated in the accommodating position which extends from the front pillar portion FP along the roof side rail portion RR to a portion thereon which is located in the vicinity of the rear pillar portion RP thereabove while passing over the first and second intermediate pillar portions P1, P2 in such a state that the airbag 12 is folded up. Then, when inflated and deployed, the airbag 12 is constructed so as to cover, as shown by a chain double-dashed line in FIG. 1, the interior sides of the windows W1, W2 which are located longitudinally in front and back of the first intermediate pillar portion P1, the window W3 which is located between the second intermediate pillar portion P2 and the widow 3 and, furthermore, the first and second intermediate pillar portions P1, P2, respectively.

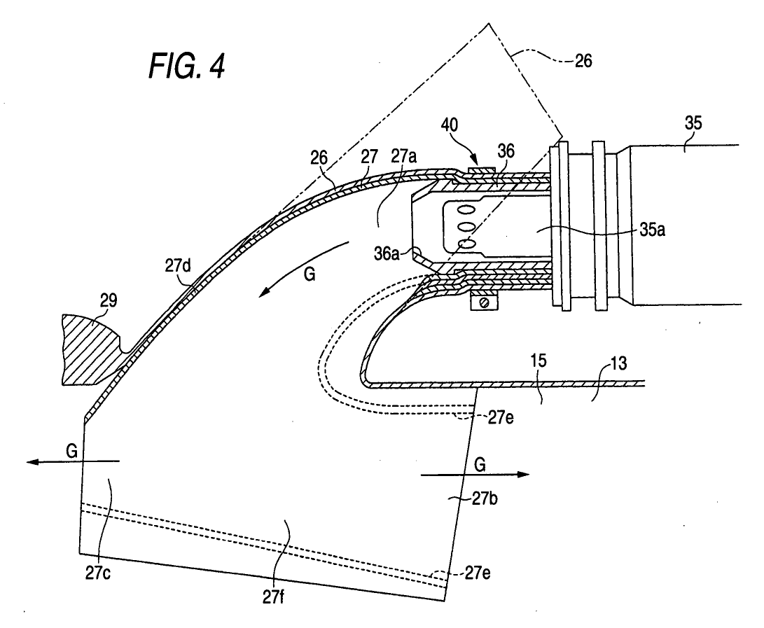

Then, the airbag 12 is, as shown in FIGS. 1, 4, provided with an airbag main body 13 and a regulator cloth 27. The airbag main body 13 includes an inflating shield portion 15 which can cover the interior sides of the intermediate pillar portions P1, P2 and the windows W1, W2, W3, when the inflation and deployment thereof has been completed by an inflating gas that has flowed thereinto, a gas inlet port portion 26 which is connected to the inflator 34 so as to supply the inflating gas to an intermediate position of the inflating shield portion 15 which excludes a front end portion and a rear end portion thereof, and a plurality of mounting portions 29 where the airbag 12 is mounted on the body 1 side of the vehicle.

The airbag main body 13 is made as a flexible bag and is formed by hollow or tubular weaving using polyamide treads or the like. Note that when woven by making use of the hollow or tubular weaving, the inflating shield portion 15, the gas inlet port portion 26 and the mounting portions 29 are fabricated integrally as the airbag main body 13. In addition, a coating agent such as silicone is coated on an external surface of the airbag main body 13 after having been woven in order to increase the heat resistance.

As shown in FIG. 4, the inflating shield portion 15 is provided with an inflating portion which inflates when the inflating gas from the inflator 34 flows thereinto and a non-inflating portion that is located around the perimeter of the inflating portion. Note that the mounting portions 29 are formed as part of the non-inflating portion.

The gas inlet port portion 26 is disposed substantially at a longitudinally intermediate position along an upper edge of the airbag main body 13 and is formed so as to project obliquely upward. To describe in detail, as shown by a chain double-dashed line in FIG. 4, the gas inlet port portion 26 is formed into a straight line while being inclined from 15 degrees to 45 degrees (about 30 degrees in this embodiment) with respect to the longitudinal direction and is assembled to the vehicle V with a distal end portion thereof bent.

The regulator cloth 27 is formed from a position of the cloth that remains after the airbag main body 13 has been woven in the hollow or tubular shape and includes a tubular inlet side portion 27a which is disposed so as to be inclined along the inside of the gas inlet port portion 26 so as to substantially contact the same and an outlet side portion 27f which is connected to the inlet side portion 27a so as to receive the gas that is caused to flow out thereof to thereby guide the gas so received into the inflating shield portion 15. The outlet side portion 27f includes a second gas outlet hole 27c which causes the gas to flow forward and a first gas outlet hole 27b which causes the gas to flow rearward.

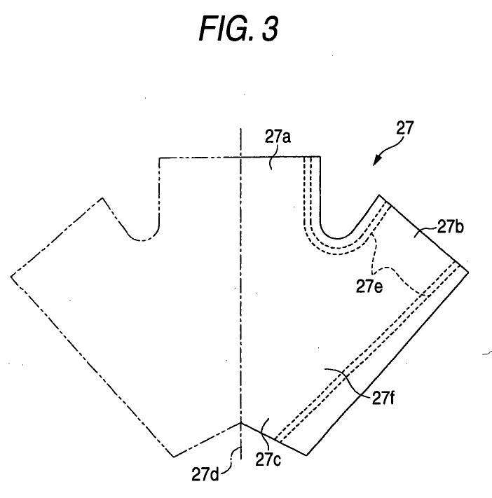

The regulator cloth 27 is, as shown in FIG. 3, formed by folding a single piece of cloth which is laterally symmetrical with each other with respect to a folding line 27d along the folding line 27d and stitching parts of the cloth so folded together at stitching portions 28.

A plurality of (seven in this embodiment) mounting portions 29 are provided so as to project upward from positions along an outer circumferential edge portion on an upper edge side of the airbag main body 13 when it is inflated and deployed. In particular, the mounting portion 29 is formed at a connecting portion between the gas inlet port portion 26 and a longitudinally front side (a side to which the gas is discharged) of the inflating shield portion 15. A mounting bracket 31 is secured to each mounting portion 29 to mount the airbag 12 on to the inner panel, and a mounting hole is formed in each mounting portion 29 so that a mounting bolt 32 is passed therethrough. Then, each mounting portion 29 is fixed to the body 1 side inner panel that is formed of a sheet metal together with the mounting bracket 31 using the mounting bolt 32.

The inflator 34 includes, as shown in FIGS. 1, 2, 4, a main body portion 35 which supplies the inflating gas for the folded airbag 12 and a diffuser 36 which guides the inflating gas that is discharged from the main body portion 35.

The main body portion 35 is formed substantially into a cylindrical shape and includes a head portion 35a from which the inflation gas is to be discharged.

The diffuser 36 is formed substantially into a short cylinder of a metal and is connected to a distal end portion of the main body portion 35 by clamping a proximal portion side of the diffuser 36 so as to cover the head portion 35a. In the diffuser 36, a gas discharge port 36a is opened in a distal end portion thereof. A connecting port portion 25 that is formed into a double layer construction by the gas inlet port portion 26 and the inlet side portion 27a is fitted on the diffuser 36, and the diffuser 36 is connected to the airbag 12 by making use of a clamp 40 that is fitted on a position of the connecting port portion 25 which is in the vicinity of a rear end thereof.

The inflator 34 is mounted on the inner panel of the body 1 utilizing the mounting bracket 38 and the mounting bolt 39 along the longitudinal direction of the vehicle V with the diffuser 36 clamped to be connected to the distal end portion of the main body portion 35.

The clamp 40 is configured so as to include a substantially arc-shaped main body portion 40a that can be fitted on the connecting port portion 25 and a bolt and a nut which constitute a fastening means which fastens ends of the main body portion 40a.

Next, the installation of the head protecting airbag apparatus M1 of the first embodiment on to the vehicle V will be described. Firstly, the airbag 12 is produced by inserting the regulator cloth 27 into the gas inlet port portion 26 such that stitched portions 27e are positioned on a rear side where they do not oppositely face the gas discharge portion 36a, and thereafter, the airbag 12 is folded up. Note that a distal end of the inlet side portion 27a of the regulator cloth 27 is thermally welded to the gas inlet port portion 26 for connection thereto. To be specific, the airbag 12 is folded into corrugations by creating recesses and ridges sequentially from a flat deployed state in which the airbag 12 has not yet been inflated such that a lower edge side is caused to approach an upper edge side thereof. Then, after folded up accordingly, the airbag 12 is wrapped therearound by a wrapping material, not shown, at a predetermined position thereof so as to prevent the collapse of the folded state, and the mounting brackets 31 are mounted in advance on the mounting portions 29, respectively. In addition, the mounting bracket 38 is also mounted in advance on the inflator 34.

Then, the connecting port portion 25, on which the clamp 40 has already been fitted, is fitted on the diffuser 36 of the inflator 34 with the regulator cloth 27 interposed therebetween, and the diffuser 36 and the airbag 12 are connected together by tightening the clamp 40 to thereby fabricate an airbag assembly.

Thereafter, as shown in FIGS. 1, 2, the mounting brackets 31, 38 are disposed at mounting positions on the body 1 side of the vehicle V and are then secured to the inner panel with the bolts 32, 39 to thereby mount the airbag assembly on to the body 1. As this occurs, the connecting port portion 25, which is provided with the gas inlet port portion 26 and the inlet side portion 27a, is bent at a distal end portion thereof, and the inflator 34 and the inflating shield portion 15 of the airbag 12 are disposed along the longitudinal direction of the vehicle V. The remaining portion of the connecting port portion 25 is disposed such that the inflating shield portion 15 and the inflator 34 are connected to each other in an inclined manner.

When the inflator 34 is activated after the installation of the airbag apparatus M1 on to the vehicle V, the inflating gas G from the inflator 34 is allowed to flow out of the gas discharge port 36a of the diffuser 36 into the inflating shield portion 15 via the inlet side portion 27a and the first and second gas outlet holes 27b, 27b of the regulator cloth 27 so as to flow to the front and rear sides of the inflating shield portion 15, whereby the airbag main body 13 starts to be inflated while unfolding the folds that have been produced as described above. Then, the airbag main body 13 breaks the wrapping material, not shown, and, furthermore, push opens the airbag cover 10 provided with the lower edges of the front pillar garnish 4 and the roof lining 5 so as to be allowed to project downward from the accommodating position to thereby inflated largely so as to cover the interior side of the windows W1, W2, W3 and the intermediate pillar portions P1, P2 as indicated by the chain double-dashed line in FIG. 1.

Then, in the airbag apparatus of the first embodiment, since the inflating gas G is made to be discharged from the gas discharge port 36a of the diffuser 36 to the front side of the vehicle, the diffuser 36 which functions as a deflecting device of the inflating gas can be formed into a short cylinder as in the case of the first embodiment, and the construction of the diffuser 36 can be simplified, thereby making it possible to reduce the production costs thereof. In addition, since the inflating gas is made to be guided obliquely downward by the inlet side portion 27a of the regulator cloth 27 and the gas inlet port portion 26 of the airbag main body 13, the damage to the inlet side portion 27a of the regulator cloth 27 against which the gas G from the gas discharge port 36a is directly blown can be reduced. Furthermore, since the front of the inlet portion side 27a is disposed along the gas inlet port portion 26 so as to substantially contact the same and the front proximal portion (the connecting portion with the inflating shield portion 15) of the gas inlet port portion 26 is fixed to the body 1, the inlet side portion 27a of the regulator cloth 27 can be supported by the gas inlet port portion 26 in an assured manner, whereby the damage that would be caused by the gas G can be reduced further, and there occurs no case where the normal state of the regulator cloth 27 is disrupted by the gas G, thereby making it possible to cause the gas G to flow in the longitudinal directions in an assured manner.

In addition, since the stitched portions 27e are made not to oppositely face the gas discharge port 36a, there occurs no case where the gas G is blown directly against the stitched portions 27e, thereby making it possible to reduce the damage of the stitched portions 27e.

Note that while, in the head protecting airbag apparatus M1 of the first embodiment, the front side (the side to which the gas G of the inflator 34 is discharged) of the inlet side portion 27a of the regulator cloth 27 is disposed so as to be brought into contact with the inside of the front side of the gas inlet port portion 26 of the airbag main body 13, since the inlet side portion 27a is brought into press contact with the gas inlet port portion 26 by the gas G, there may be remaining a gap between the inlet side portion 27a and the gas inlet port portion 26 at the relative position. Furthermore, while the mounting portion 29 is provided at the connecting portion between the front side of the gas inlet port portion 26 and the inflating shield portion 15, the mounting portion 29 maybe spaced apart from the gas inlet portion 26 provided that they are close enough to each other to maintain the afore-discussed supporting effect by the inlet side portion 27a.

In addition, while the gas G is made to be discharged forward from the inflator 34, the gas G may be made to be discharged rearward. In this case, the positions of the regulator cloth and the gas inlet port portion may be reversed laterally from those discussed in the first embodiment.

### Second Embodiment

Second embodiment of the invention will be described below based on the drawings. A head protecting airbag apparatus M2 according to the second embodiment is installed on the vehicle V in similar matter to the first embodiment as shown in FIG. 1.

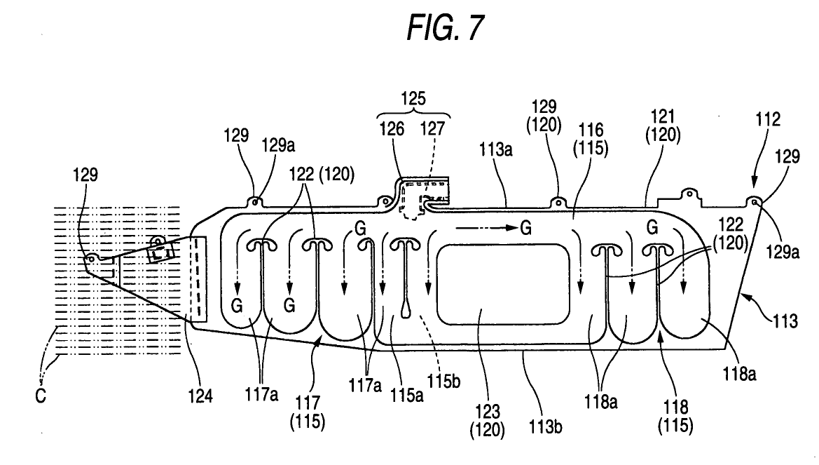

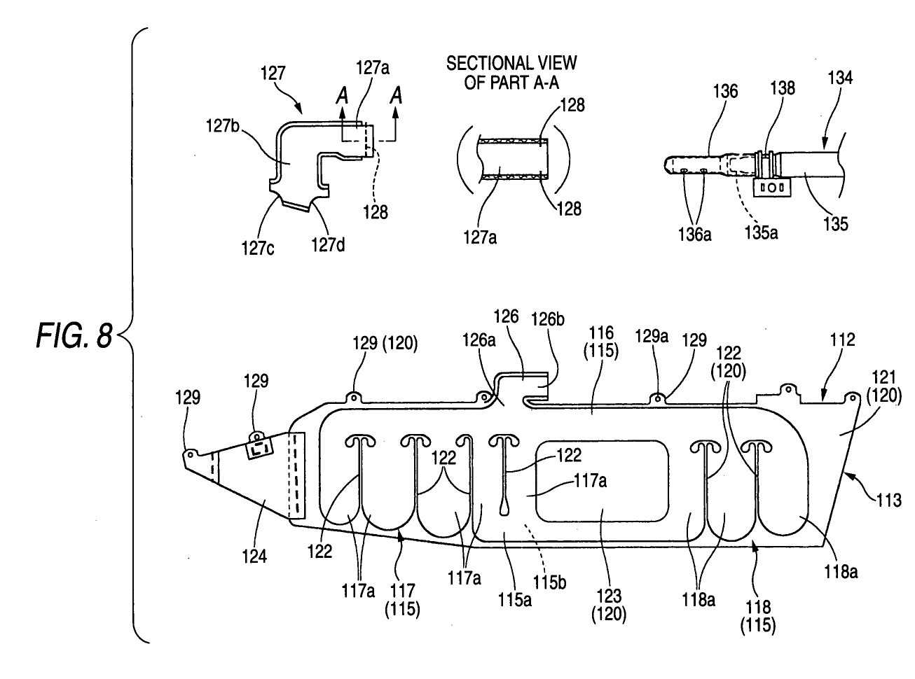

An airbag 112 is, as shown in FIGS. 7, 8, provided with a main body portion 113 which can cover the interior side of the intermediate pillar portions P1, P2 and the windows W1, W2, W3 when the airbag 112 completes its inflation and deployment, a connecting port portion 125 that is connected to the inflator 134 to supply an inflating gas into the interior of the main body portion 113 and a plurality of mounting portions 129 for mounting the airbag 112 in the accommodating position P to the body 101 side of the vehicle. In the case of this embodiment, the connecting port portion 125 is made to have a double layer construction which is provided with an outer peripheral portion 126 that is constructed integrally with the main body portion 113 and an inner tube 127 that is made to be a separate body from the main body portion 113.

The main body portion 113 is made as a flexible bag and is formed by hollow or tubular weaving using polyamide treads or the like. Note that when woven by making use of the hollow or tubular weaving, the outer peripheral portion 126 of the connecting port portion 125 and the mounting portions 129 are fabricated integrally as the airbag main body 113. In addition, a coating agent such as silicone is coated on an external surface of the main body portion 113 after having been woven in order to increase the heat resistance.

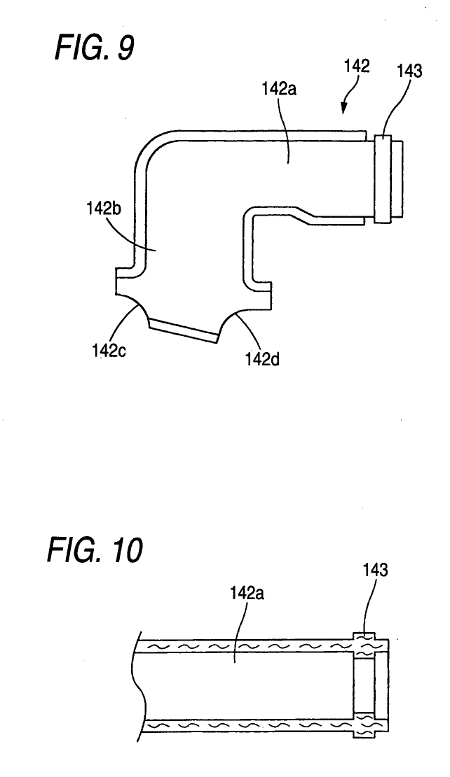

The main body portion 113 is, as shown in FIGS. 7, 9, provided with a gas flowing portion 115 which is adapted to be inflated by an inflating gas that flows from the inflator 134 so as to separate an internal wall portion 115a and an external wall portion 115b from each other and a non-gas-flowing 120 which is formed such that the internal wall portion 115a and the external wall portion 115b are connected together so as to prohibit the flow of inflating gas thereinto. Note that while in the case of the second embodiment, the main body portion 113 is configured so as to include a separate cloth material 124 from the main body portion 113 which is stitched to a front end side thereof, the position of this cloth material 124 may be formed integrally with the main body portion 113 by hollow or tubular weaving.

The gas flowing portion 115 includes a front inflating portion 117 which is adapted to be inflated and deployed so as to cover the interior side of the window W1 at the side of a front seat and a rear inflating portion 118 which is adapted to be inflated and deployed so as to cover the interior side of the window W2 at the side of a rear seat, when the inflating gas flows into the gas flowing portion 115, and the gas flowing portion 115 also includes a gas supply path portion 116 which is provided to extend along a longitudinal direction of the vehicle V so as to allow the inflating gas from the connecting port portion 125 into the front and rear inflating portions 117, 118.

The non-gas-flowing portion 120 includes an outer circumferential edge portion 121 that is provided so as to surround the gas flowing portion 115, restricting portions 122 and a plate-shaped portion 123. The restricting portions 122 are provided at a plurality of positions within areas of the front and rear inflating portions 117, 118 so as to extend linearly in a vertical direction so as to restrict the thickness of the front and rear inflating portions 117, 118 in such a way that the thickness thereof is not increased locally when both the inflating portions complete their inflation, so that plate-like shapes thereof can be maintained. These restricting portions 122 are formed into a T-shape or an inverted J-shape so as to extend vertically from the outer circumferential edge portion 121 on a lower edge 113b side of the main body portion 113 or so as to be spaced away from the outer circumferential edge portion 121. Note that the front and rear inflating portions 117, 118 are respectively divided into a plurality of vertical cells 117a, 118a which extend vertically. The plate-shaped portion 123 is formed into a rectangular plate-like shape and is provided below the gas supply path portion 116 between the front and rear inflating portions 117, 118.

The outer peripheral portion 126 which makes up the connecting port portion 125 is disposed on an upper edge 113a side of the main body portion at a longitudinally intermediate position, or, in the case of the second embodiment, at a position above a rear end of the front inflating portion 117 and is formed so as to project upward. To be specific, the outer peripheral portion 126 is formed substantially into an L-shape which includes a vertical tubular portion 126a which extends upward from the gas supply path portion 116 and a horizontal tubular portion 126b which extends rearward from an upper end of the vertical tubular portion 126a with a rear end of the horizontal tubular portion 126b made to open.

In addition, the inner tube 127 which makes up an inner peripheral portion of the connecting port portion 125 is formed by a position which remains after the main body portion 113 has been woven in a hollow tubular weaving shape and includes a horizontal tubular portion 127a which is disposed within the horizontal tubular portion 126b of the outer peripheral portion 126 and a vertical tubular portion 127b which extends downward from a front end of the horizontal tubular portion 127a so as to reach the gas supply path portion 116. Gas outlet ports 127c, 127d are opened in a lower end of the vertical tubular portion 127b in such a manner as to allow the inflating gas to flow out therethrough obliquely downwardly forward and rearward when the vertical tubular portion 127b is disposed in the area of the gas flow path 116 of the main body portion 113 associated with the provision of the inner tube 127 within the outer peripheral portion 126. Then, a stitched portion 128, which functions as a raised portionmaking up a projecting portion 125a of the connecting port portion 125, is formed using a stitching thread at a position of the horizontal tubular portion 127a which is located further rearward than a clamp 140 when the connecting port portion 125 is connected to a diffuser 36. This stitched portion 128 is formed around the full circumference of the horizontal tubular portion 127a so as to project from a surface of the horizontal tubular portion 127a and is provided to prevent the dislodgement of the connecting port portion 125 from the diffuser 136.

Then, the connecting port portion 125 is fitted on the diffuser 136, which will be described later on, of the inflator 134 such that gas discharge ports 136a are disposed in the vicinity of an upper position of the vertical tubular portion 127b. The connecting port portion 125 is connected to the diffuser 136 by tightening the clamp 140 of a sheet metal in such a state that the connecting port portion 125 is fitted on the diffuser 136.

A plurality (seven in the case of this embodiment) of mounting portions 129 are provided so as to project upward from positions along the outer circumferential edge portion 121 on the upper edge 113a side of the main body portion 113 and a position on the cloth material 124 when the main body portion is inflated and deployed. A mounting bracket 131 is secured to each mounting portion 129 which is used to mount the airbag 112 on to the inner panel 102, and a mounting hole 129a is formed in each mounting portion 129 through which a mounting bolt 132 is passed. Then, each mounting portion 129 is fixed together with the mounting bracket 131 to the body 101 side sheet metal inner panel 102 at the accommodating position P with a mounting bolt 132.

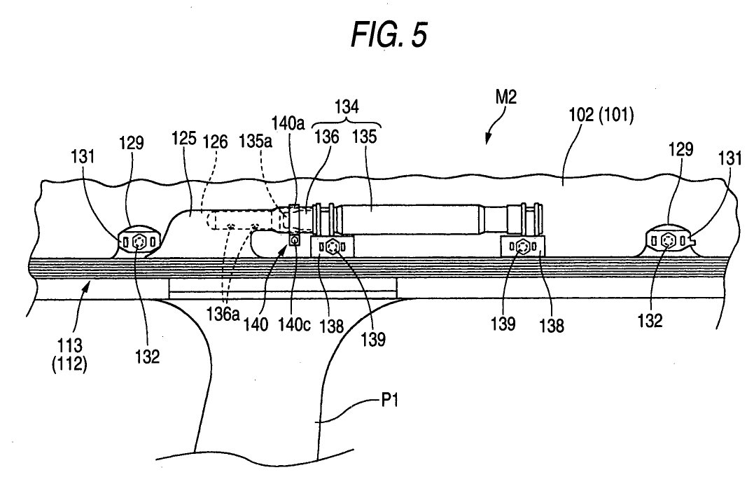

The inflator 134 includes, as shown in FIG. 5, a main body portion 135 which supplies inflating gas for the folded airbag 112 and the diffuser 136 which guides the inflating gas that is discharged from the main body portion 135.

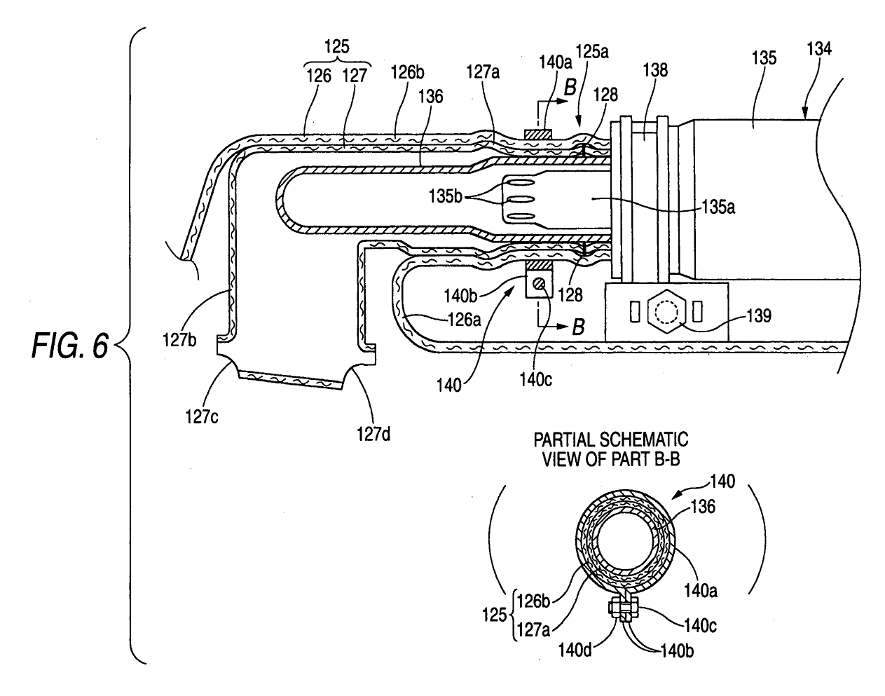

The main body portion 135 is formed substantially into a cylindrical shape and includes a head portion 135a at a distal end side thereof. Then, a gas discharge port 135b is formed in the head portion 135a which is adapted to discharge an inflating gas (refer to FIG. 6).

The diffuser 136 is formed of a substantially cylindrical metallic pipe material whose distal end is closed and is connected to a distal end of the main body portion 135 by clamping a proximal portion side of the diffuser 136 so as to cover the head portion 135a. The two gas discharge ports 136a are opened in a lower surface of a distal end side of the diffuser 136 in series in the longitudinal direction of the vehicle V. The connecting port portion 125 of the airbag 112 is fitted on the diffuser 136, and the diffuser 136 is connected to the airbag 112 by utilizing the clamp 140 that is fitted on the connecting port portion 125 at a position in the vicinity of a rear end thereof.

The inflator 134 is mounted on the inner panel 102 of the body 1 along the longitudinal direction of the vehicle V using the mounting brackets 138 and the mounting bolts 139 in such a state that the diffuser 136 is clamped to be connected to the distal end of the main body portion 113.

The clamp 140 includes a substantially arc-shaped main body portion 140a which can be fitted on the connecting port portion 125, lug portions 140b, 140b which are formed on ends of the main body portion 140a and a bolt 140c and a nut 140d which function as a fastening means for fastening the lug portions 140b, 140b. In the clamp 140, the main body portion 140a is disposed around the circumference of the connecting port portion 125 that is fitted on the diffuser 136, and the bolt 140c is fastened to the nut 140d provided on one of the lug portions 140b, whereby the connecting port portion 125 is connected to the diffuser 136 by fastening the main body portion 140a to the diffuser 136 side.

Next, the installation of the head protecting airbag apparatus M2 of the second embodiment on to the vehicle V will be described. Firstly, the airbag 112 is produced by inserting the inner tube 127 into the outer peripheral portion 126, and thereafter, the airbag 112 so produced is folded up. Note that the inner tube 127 is thermally welded to the outer peripheral portion 126. To be specific, the airbag 112 is folded up into corrugations by creating recesses and ridges sequentially from a flat deployed state in which the airbag 112 has not yet been inflated such that a lower edge 113b side of the main body portion 113 is caused to approach an upper edge 113a side thereof as shown with chained double-dashed line in FIG. 7. Then, after folded up accordingly, the airbag 112 is wrapped therearound by a wrapping material, not shown, at a predetermined position thereof so as to prevent the collapse of the folded state, and the mounting brackets 131 are mounted in advance on the mounting portions 129, respectively. In addition, the clamp 140 is mounted in advance at a position on the connecting port portion 125 which is located further forward (the main body portion 113 side) than the projecting portion 125a on the connecting port portion 125, and the mounting bracket 138 is also mounted in advance on the inflator 134.

Then, the connecting port portion 125, on which the clamp 140 has already been fitted, is fitted on the diffuser 136 of the inflator 134 with the inner tube 127 interposed therebetween, and the diffuser 136 and the airbag 112 are connected together by fastening the bolt 140c of the clamp 140 to the nut 140d thereof to thereby tighten the main body portion 140a of the clamp 140, whereby an airbag assembly is fabricated.

Thereafter, the mounting brackets 131, 138 are disposed at the accommodating position P on the body 101 side of the vehicle so as to be fastened to the inner panel 102 with the bolts 132, 139, whereby the airbag assembly is mounted on to the body 101. Following this, a lead wire, not shown, that extends from a predetermined inflator operation controlling unit is connected to the inflator 134, the pillar garnish 4 and the roof lining 5 (See FIG. 1.) are fixedly mounted on the body 101, and furthermore, pillar garnishes 6, 7, 8 (FIG. 1) are mounted on the body 101, whereby the airbag apparatus M2 can be installed on to the vehicle V.

Thereafter, in the event that the inflator 134 is activated after the installation of the airbag apparatus M2 on to the vehicle M, the inflating gas G from the inflator 134 is supplied to the gas supply path portion 116 of the gas flowing portion 115 from the respective gas discharge ports 136a of the diffuser 136 via the connecting port portion 125, and the inflating gas G so supplied continues to flow further into the respective vertical cells 117a, 118a of the front and rear inflating portions 117, 118 as indicated by chain double-dashed lines in FIG. 7, whereby the main body portion 113 of the airbag 112 starts to inflated while unfolding the folds that are formed as has been described above. Then, the main body portion 113 breaks the wrapping material, not shown, and furthermore, push opens the airbag cover 10 (see FIG. 1) provided with the lower edges of the front pillar garnish 4 and the roof lining 5 so as to project downward from the accommodating position P, whereby the main body portion 113 inflates largely to such an extent that the interior side of the windows W1, W2, W3 and the intermediate pillar portions P1, P2 are covered as indicated by the chain double-dashed line in FIG. 1.

Then, in the airbag apparatus M2 of the second embodiment, since the projecting portion 125a (the stitched portion 128 of the inner tube 127) is formed at the position on the connecting port portion 125 of the airbag 112 which is located further rearward than the clamp 140 so as to prevent the dislodgement of the connecting port portion 125 from the diffuser 136 of the inflator 134, even in the event that, for example, the connecting port portion 125 of the airbag 112 is pulled so abruptly and violently as to attempt to be dislodged from the diffuser 136 at the early stage of inflation of the airbag 112 after the connecting port portion 124, which has already been fitted on the diffuser 136 of the inflator 134, is connected to the diffuser 136 by tightening the clamp 140, the projecting portion 125a (the stitched portion 128) is caught between the inflator 134 and the diffuser 136 to thereby function as a wedge, which prevents the dislodgement of the clamp 140 and the connecting port portion 125 from the diffuser 136. Due to this, when compared with the related art airbag apparatuses in which no such projecting portion is provided, the connection strength of the connecting port portion 125 with the inflator 134 can be increased.

Consequently, in the airbag apparatus M2 of the second embodiment, even in the event that the connecting port portion 125 of the airbag 112 is constructed so as to be connected to the inflator 134 by making use of the clamp 140, the connection strength can be increased.

In addition, in the airbag apparatus M2 of the second embodiment, the stitched portion 128 may only have to be formed on the inner tube 127 which makes up the connecting port portion 125, the provision of the projecting portion 125a can easily be coped with without changing largely the design of the airbags used in the related art airbag apparatuses. In particular, in the airbag apparatus M2 of the second embodiment, since the stitched portion 128 is formed on the inner tube 127 which is separate from the main body portion 113, the airbags that are used in the related art airbag apparatuses can be used as they are.

Furthermore, in the airbag apparatus M2 of the second embodiment, since the projecting portion 125a is provided with the stitched portion 128 that is formed by utilizing stitching threads, the stitched portion may only have to be formed on the related art airbags by utilizing stitching threads, the provision of the projecting portion can be coped with more easily.

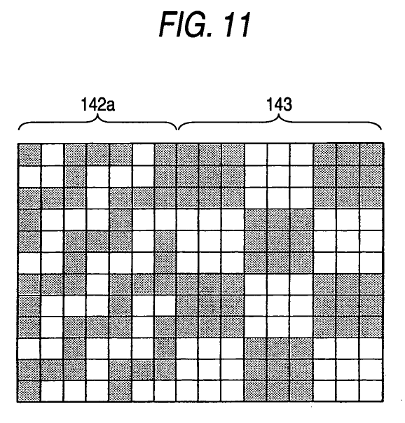

In addition, a configuration shown in FIGS. 9, 10 maybe used as an inner tube 142. Similar to the aforesaid inner tube 127, the inner tube is made by hollow or tubular weaving and is provided with a horizontal tubular portion 142a which is disposed within the horizontal tubular portion 126b of the outer peripheral portion 126, a vertical tubular portion 142b which extends downward from a front end of the horizontal tubular portion 142a so as to reach the gas supply path portion 116 and gas outlet holes 142c, 142d which are provided in a lower end of the vertical tubular portion 142b. Then, a raised portion 143 which makes up the projecting portion adapted to prevent the dislodgement of the connecting port portion 125 from the diffuser 136 is formed on the horizontal tubular portion 142 at a position thereon which is located in the vicinity of a rear end of the vertical tubular portion 142a. In the case of the second embodiment, the raised portion 143 is provided by changing the thickness of a woven structure of the position formed by the hollow or tubular weaving at a position thereon where the raised portion 143 is to be provided so as to be increased. To be specific, the inner tube 142 is constructed such that the woven structure of the position where the raised portion 143 is provided is, as shown in FIG. 11, made to be composed of a satin weave of 3×3 and the thickness thereof is thicker than the other positions of the horizontal tubular portion 142a that are composed of a plain weave of 1×1. In case the configuration like this is adopted, the raised portion can be produced together with the inner tube 142 when the inner tube 142 is produced by hollow or tubular weaving, thereby making it possible to omit a process for forming a raised portion separately.

Note that in the head protecting airbag apparatus M2 of the second embodiment, the airbag is used in which the inner tube 127 (142) is provided at the position where the connecting port portion 125 is provided so as to form the connecting port portion 125 into the double layer construction, and the raised portion 128 (143) which makes up the projecting portion 125a is provided on the inner tube 127 (142). Of course, the airbag apparatus of the invention can also be applied to an airbag apparatus which utilizes an airbag having a connecting port portion with a single layer construction in which no inner tube is provided. Furthermore, in the case of the airbag in which the connecting port portion is formed into the double layer construction, a configuration may be adopted in which the raised portion which makes up the projecting portion is formed on both a position on the airbag which makes up the outer peripheral side of the connecting port portion and the inner tube. In addition, in the second embodiment, while the raised portion 127, 143 is constructed so as to be provided continuously around the full circumference of the horizontal tubular portion 127a, 142a of the inner tube 127, 142, the raised portion may be provided intermittently.

In addition, while the second embodiment has been described by taking as an example the head protecting airbag apparatus, airbag apparatuses to which the invention can be applied are not limited thereto, and hence the invention may be applied to a side airbag apparatus or the like.

What is claimed is:

1. A head protecting airbag apparatus mounted in an upper portion of a window of a vehicle, comprising:
an inflator having a gas discharge port which discharges an inflating gas in a longitudinal direction of the vehicle;
an airbag folded and adapted to be deployed downward so as to cover an interior side of the window when the inflating gas flows thereinto, the airbag including an airbag main body and a flexible regulator cloth,
wherein the airbag main body includes
an inflating shield portion which inflates by flowing the inflating gas thereinto to shield the interior side of the window, and
a gas inlet port portion connected to the inflator, projecting obliquely upward from an upper portion of the inflating shield portion except for portions in vicinity of a front end and a rear end thereof,
wherein the regulator cloth includes
a tubular inlet side portion disposed within the gas inlet port portion to be connected to the inflator and an outlet side portion disposed at a position on the inflating shield portion which is located in a vicinity of the gas inlet port portion,
the inlet side portion is adapted to guide downward the inflating gas discharged from the inflator, and
the outlet side portion includes a first gas outlet hole and a second gas outlet hole which are adapted to allow the inflating gas flowing out of the inlet side portion to flow, to a front side and a rear side along the inflating shield portion in a longitudinal direction of the vehicle.

2. A head protecting airbag apparatus according to claim 1, wherein the inlet side portion of the regulator cloth is formed into a tubular shape from a single piece of cloth by a stitched portion that is formed using a stitching thread, and wherein the stitched portion is disposed so as not to face the gas discharge port.

3. A head protecting airbag apparatus according to claim 1, wherein a connecting portion between the inflating shield portion and a gas discharge side of the gas inlet port portion of the airbag main body or a portion in a vicinity of the connecting portion is fixed to a body of the vehicle.

4. An airbag apparatus comprising:
an airbag folded and accommodated in a accommodating position of a vehicle, capable of projecting from the accommodating position for expansion and deployment by flowing an inflating gas thereinto; and
an inflator for supplying the inflating gas for the airbag;
wherein the airbag includes a tubular connecting port portion fitted on the inflator and connected thereto by being fastened by a clamp for allowing the inflating gas from the inflator into the airbag, and
wherein the connecting port portion has a projecting portion provided at a position thereon which is located further forward than the clamp when the connecting port portion is connected to the inflator which prevents the connecting port portion from being detached from the inflator.

5. An airbag apparatus according to claim 4, wherein the projecting portion is provided with a stitched portion that is formed by utilizing a stitching thread.

6. An airbag apparatus according to claim 4, wherein a hollow or tubular weaving is provided at a position of the airbag where the connecting port portion is provided, and
the projecting portion is provided by changing a woven structure of the hollow or tubular weaving so that a thickness of the projecting portion is increased.
